(19) United States
(12) Patent Application Publication
(10) Pub. No.: US 2025/0186283 A1
(43) Pub. Date: Jun. 12, 2025

(54) PATIENT SLING

(71) Applicant: Human Care HC AB, Stockholm (SE)

(72) Inventors: Stefan HEDELIUS, Stockholm (SE); Elizabeth MORAND, Stockholm (SE)

(21) Appl. No.: 18/544,911

(22) Filed: Dec. 19, 2023

(30) Foreign Application Priority Data
Dec. 8, 2023 (SE) 2351406-0

(51) Int. Cl. A61G 7/10

(52) U.S. Cl. CPC A61G 7/1023; A61G 7/1044; A61G 7/1051; A61G 2200/32

(57) ABSTRACT

A patient sling for handling patients, comprising a support layer comprising a first fabric, and having a first side and a second side opposite to the first side of the support layer. The patient sling further comprises a patient layer comprising a second fabric, and having a first side and a second side, opposite to the first side of the patient layer, wherein the second side of the patient layer is attachable to the first side of the support layer, and the first side of the patient layer is configured to be in contact with the body of a patient. The patient sling further comprises a plurality of lifting means arranged along opposite edges of the support layer. Furthermore, the first fabric comprises a mesh structure, and the second fabric comprises a woven structure.

### FIELD OF THE INVENTION

The present invention generally relates to the field of patient slings for handling patients. More specifically, the present invention relates to a combined patient sling and bedsheet for patients.

### BACKGROUND OF THE INVENTION

Patient slings play a crucial role within healthcare, providing a way to safely lift, transfer, and reposition individuals with limited mobility or whom require assistance due to illness, injury, or disability. Patient slings are key components in regard to patient handling and mobility programs, contributing to both the comfort of the patient and the safety of the operator. A patient sling is often used in combination with a patient lift system comprising mechanical devices assisting in lifting and transferring the patient. The patient sling is attached securely to the lift, allowing for controlled and safe movements of the patient.

Patients in need of patient slings for transportation may be particularly vulnerable of developing skin ulcers, due to a reduced ability to move or change position. The limited mobility of the patient may give rise to prolonged pressure on specific areas of the body, and increased friction and shear forces when the patient is moved or repositioned, thus increasing the risk of mechanical skin irritations, trauma, and skin ulcers. In order to increase the skin health of the patient, treatment may involve various aspects, such as regular repositioning, skin inspections, moisture management, and specialized supportive mattresses and cushions.

At the same time, each lift, transfer or repositioning of the patient using a patient sling must be carried out with care to reduce the risk of exposing the patient of unnecessary pressure, friction, constriction, or shear forces. Additionally, transferring the patient on and off the patient sling introduces further skin health risks. Present patient slings are often made of durable and stiff material in order to provide support during lifting, transferring, and repositioning of patients, material which may have a negative impact on the skin condition of the patient.

Hence, it is of interest to mitigate at least some of the above-mentioned problems when handling a patient with a patient sling.

### SUMMARY OF THE INVENTION

It is an object of the present invention to provide a two-layer combined patient sling and bedsheet to prevent moisture build up and elevated temperature in regard to a patient positioned in the patient sling, while simultaneously increasing the overall comfort and safety for the patient.

This and other objects may be achieved by a patient sling having the features in the independent claim. Preferred embodiments are defined in the dependent claims.

Hence, according to the present invention, there is provided a patient sling for handling patients, comprising a support layer comprising a first fabric, and having a first side and a second side opposite to the first side of the support layer. The patient sling further comprises a patient layer comprising a second fabric, and having a first side and a second side, opposite to the first side of the patient layer. The second side of the patient layer is attachable to the first side of the support layer, and the first side of the patient layer is configured to be in contact with the body of a patient. The patient sling further comprises a plurality of lifting means arranged along opposite edges of the support layer. Furthermore, the first fabric comprises a mesh structure, and the second fabric comprises a woven structure.

It will be appreciated that the patient sling comprises two different layers, the support layer and the patient layer. The patient layer is arranged to receive the patient, whilst lifting means are attached to the support layer to enable lifting, transferring, and/or repositioning of the patent. This two-layer combination in a patient sling allows for a patient to remain in the patient sling for a period of time to rest and/or sleep, instead of the requirement of transferring the patient from the patient sling onto a conventional bed sheet. Therefore, the amount of redundant adjusting movements of the patient is reduced, thus reducing the risk of skin trauma inflicted to the patient due to friction, shear force, contraction, and/or pressure.

It will be further appreciated that the first fabric comprises a mesh structure, and that the second fabric comprises a woven structure. The mesh structure of the first fabric and the woven structure of the second fabric provide for a breathable support layer and patient layer, respectively, thus resulting in a breathable patient sling. This is advantageous in that an increased air circulation in connection to the patient reduces the risk for skin trauma such as developing skin ulcers. The overall comfort for the patient may also be increased alongside increased air circulation.

It should be noted that the lifting means are arranged along opposite edges of the support layer. Hence, the lifting means are not arranged on the patient layer. Therefore, the arrangement of the lifting means will not be in the way for a patient placed in the patient sling, where said lifting means otherwise may have caused discomfort and/or have a negative impact on the skin health of the patient.

Furthermore, due to the presence of two different layers of the patient sling, the second fabric of the support layer may be designed to have a high durability and ensuring a secure attachment of said lifting means, whilst the second fabric of the patient layer may be designed according to the comfort of the patient.

According to the present invention, there is provided a patient sling. By the term “patient sling”, it is here meant a harness, strap, band, or any other suitable supportive equipment to assist in the lifting and transferring of individuals with e.g., limited mobility. Hence, a patient sling includes a positioning sling, a universal sling, a toileting sling, etc. Furthermore, the patient sling comprises a support layer and a patient layer, wherein the patient layer is attachable to the support layer. By “attachable”, it is here meant that the patient layer is connectable, affixable, fixable, or the like to the support layer. In other words, the patient layer may be removed from the support layer in order to e.g., cleaning the patient layer, and thereafter reattach said patient layer to said support layer.

The support layer comprises a first fabric comprising a mesh structure. By “mesh structure”, it is here meant an arrangement, composition, texture, or the like characterised by an open-grid-like pattern, creating a series of openings, voids, cavities, or the like in order to provide for a breathable (first) fabric. Furthermore, the patient layer comprises a woven structure. By “woven structure”, it is here meant an arrangement, composition, texture, or the like, of elements within a (second) fabric, constructed by interlacing threads, fibres, yarns, or the like, to form a patterned and interconnected (second) fabric.

According to an embodiment of the present invention, the first fabric may comprise a first synthetic material, and the second fabric comprises a second synthetic material. This is advantageous in that the first and second synthetic material may be engineered according to specific needs, requirements, and desires of a user. For example, such desires may include maximizing the breathability of the first and second fabric and/or maximizing moisture wicking and drying properties. Furthermore, using synthetic material such as polyester and nylon provides for high durability and resistance to wear and tear. Additionally, the use of synthetic material may present a cost-efficient choice of material, and/or allow for a high production rate.

According to an embodiment of the present invention, the mesh structure of the first fabric may be configured to transport at least one of moisture and heat away from the patient. This is advantageous in that the mesh structure may provide heat dissipation and/or moisture management in relation to the patient in contact with the patient sling. Mentioned properties are beneficial in regard to at least the skin health of the patient. Allowing moisture and heat to be transferred away from the patient may reduce the risk of skin breakdown and skin ulcers, which may otherwise result in pressure ulcers. The present embodiment is further advantageous in that it may also increases the overall comfort for the patient by preventing moisture build up and overheating. Additionally, transporting away moisture and/or heat from the patient may result in a pleasant cooling sensation for the patient.

According to an embodiment of the present invention, the patient layer may extend along an longitudinal direction, AL, and a horizontal direction, AH, perpendicular to the longitudinal direction, AL, and wherein the woven structure of the second fabric may comprise a plurality of continuous filament fibres. At least a first portion of the plurality of continuous filament fibres may be arranged along the longitudinal direction, AL, and at least a second portion of the plurality of continuous filament fibres may be arranged along the horizontal direction, AH. This is advantageous in the woven structure of the second fabric may comprise a plurality of continuous filament fibres. By the use of continuous filament fibres, instead of for example short, staple fibres found in cotton, the patient layer may reduce the risk of skin trauma of the patient due to friction, shear, and/or contraction. Instead, the patient layer provides for a smooth, even, level, continuous, or the like surface to be in contact with the patient. In other words, the patient layer provides an absence of undesirable abutments, protrusions, elevations, projections, or the like to be in contact with the patient. Furthermore, the use of continuous filament fibres may reduce the amount of bacteria and/or fungi to grow and/or spread in the patient layer.

According to an embodiment of the present invention, the plurality of continuous filament fibres of the second fabric may be arranged to establish micro-channels in the second fabric configured to transport at least one of moisture and heat away from the patient. Hence, the arrangement of the plurality of continuous filament fibres establish micro-channels in the second fabric, wherein the micro-channels allows for moisture wicking and/or heat dissipation. This is advantageous in that the micro-channels transporting moisture and/or heat away from the patient may reduce the risk for skin trauma for the patient, such as developing skin ulcers.

According to an embodiment of the present invention, wherein the micro-channels of the second fabric may be established by the plurality of continuous filament fibres of the second fabric having a clover-shaped cross-section. Hence, the continuous filament fibres may have a non-circular cross-section. This is advantageous in that the continuous filament fibres having a clover-shaped cross-section may optimize the transportation of moisture and heat away from the patient in regard to at least time.

According to an embodiment of the present invention, the second fabric may comprise an antimicrobial coating. This is advantageous in that the antimicrobial coating of the second fabric may prevent growth of bacteria and/or fungi. Thus, the present embodiment reduces the progress of odour and extent of staining of the patient sling. Subsequently, the antimicrobial coating may increase the longevity of the patient sling as the need of laundering of the patient sling may be reduced. Furthermore, the antimicrobial coating reduces the amount of potential harmful bacteria and/or fungi in contact with the skin of the patient. Thus, the present embodiment is further advantageous in that it may reduce the risk of harmful bacteria and/or fungi coming in contact with the patient, which could otherwise lead to e.g., infections, inflammation, and/or allergic reactions.

According to an embodiment of the present invention, the first side of the support layer may have a first coefficient of friction, and the second side of the support layer may have a second coefficient of friction, wherein the second coefficient of friction may be higher than the first coefficient of friction. In other words, the second side of the support layer, arranged to come in contact with e.g., a mattress, may have a higher coefficient of friction in regard to the coefficient of friction of the first side of the support layer, arranged to receive the patient layer. This is advantageous in that the relative high coefficient of friction of the second side of the support layer may prevent the patient sling separating from the mattress. This is beneficial in scenarios when for example the patient, positioned in the patient sling, is situated in a wheelchair, on a bed, etc. Simultaneously, the coefficient of friction of the first side of the support layer is relative low. This is advantageous as the first side of the support layer aligns with the first side of the patient layer, i.e., the side of the patient sling that is configured to be in contact with the body of the patient.

According to an embodiment of the present invention, the lifting means may comprise loops. This is advantageous in that the lifting means comprising loops may facilitate lifting, transferring, and/or repositioning of a patient in the patient sling. The lifting means comprising loops may be more securely attached, fastened, connected, or the like to a patient lift system. Hence, the present embodiment provides for an easy and secure way of attaching the patient sling to for example hooks on a patient lift system. This may reduce the risk of harm coming to the patient during lifting, transferring, and/or repositioning the patient related to mismanagement of the patient sling due to e.g., human error.

According to an embodiment of the present invention, each of the loops of the lifting means may be configured to be length-adjustable by comprising sub-loops, wherein each of the sub-loops of a loop is of different lengths. This is advantageous in that the present embodiment provides for a more versatile patient sling, regarding different design needs, desires, and/or requirements, according to e.g., various sizes of patients, desired freedom of movement for the patient, and/or desired patient positioning during lifting, transferring, and/or repositioning, etc. For example, it may be desirable to be able to have the head of the patient at an elevated angle compared to the rest of the body of the patient during transfer. Thus, the present embodiment may provide for a more adaptable, secure, and/or comfortable patient sling.

According to an embodiment of the present invention, the support layer may comprise mattress fixation means configured to releasably fixate the patient sling to a mattress. Hence, the patient sling may be reversibly fixated to i.e., a mattress. This is advantageous in that the mattress fixation means allows for a more secure fixation of the patient sling to e.g., a mattress, a bed, or the like. Therefore, the risk of the patient sling separating from the mattress may be reduced. As the patient sling is configured to be used as a combined patient sling and bedsheet, the patient may remain on the patient sling for a duration of time in order to rest and/or sleep. Therefore, the present embodiment provides a more secure environment for the patient by reducing the risk of the patient residing in the patient sling of falling, sliding, declining, or the like, from a mattress, a bed, or any other object where the patient is intended to remain for a duration of time.

According to an embodiment of the present invention, the mattress fixation means may be configured to be threaded around the mattress and may comprise at least one of a plurality of elastic bands provided in corners of the support layer, and arranged on the second side of the support layer, and an elastic enclosure arranged along the perimeter of the support layer. Hence, the mattress fixation means may comprise both elastic bands and an elastic enclosure, or only one of them. The present embodiment is advantageous in that the mattress fixation means allows for a more secure fixation of the patient sling to e.g., a mattress. Furthermore, as the present mattress fixation means are arranged on the second side of the support layer and/or along the perimeter of the support layer, and are configured to be threaded around the mattress, the mattress fixation means does not present a hindrance for the patient or their surroundings when the patient is placed in the patient sling, and the patient sling is arranged on the mattress. Furthermore, the configuration of the mattress fixation of the support layer allows for the patient sling with the patient to be placed in for example a wheelchair without the risk of the patient sling presenting a hindrance for e.g., the wheels of the wheelchair.

### BRIEF DESCRIPTION OF THE DRAWINGS

FIG. 1 is a schematic top view of a patient sling according to an exemplifying embodiment of the present invention.

FIG. 2 is a schematic bottom view of a patient sling according to an exemplifying embodiment of the present invention.

FIG. 3 is a schematic perspective view of a patient sling according to an exemplifying embodiment of the present invention when attached to a patient lift system (not shown).

FIGS. 4a and 4b are selected enlarged schematic top and side views, respectively, of a patient sling according to an exemplifying embodiment of the present invention.

FIG. 5 is a schematic perspective view of various cross-sections of a plurality of continuous filament fibres.

### DETAILED DESCRIPTION

The present invention will now be described more fully hereinafter with reference to the accompanying figures, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

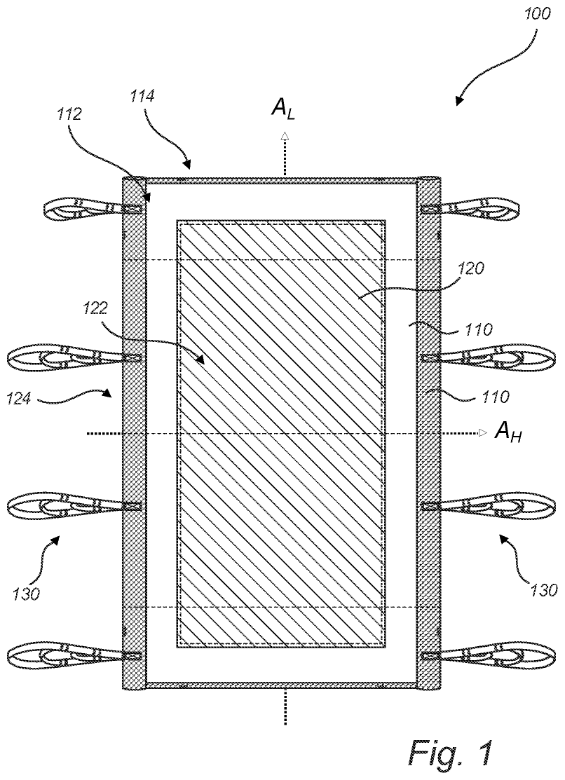

FIG. 1 is a schematic top view of a patient sling 100 according to an exemplifying embodiment of the present invention.

The patient sling 100 of FIG. 1 extends along a longitudinal direction, A_{L}, and a horizontal direction, A_{H}, perpendicular to the longitudinal direction, A_{L}. The patient sling 100 for handling patients comprises a support layer 110 comprising a first fabric. The first fabric may be of a breathable fabric. Furthermore, the first fabric may comprise a synthetic material. Said synthetic material may be at least one of polyester and nylon. Hence, the synthetic material of the first fabric may comprise a polyester, a nylon, or a combination thereof. The support layer 110 has a first side 112 and a second side 114 (not shown) opposite to the first side 112 of the support layer 110. According to FIG. 1, the support layer 110 has the shape of a rectangle.

The patient sling 100 of FIG. 1 further comprises a patient layer 120 comprising a second fabric. The second fabric may be of a breathable fabric. Furthermore, the second fabric may comprise a synthetic material. Said synthetic material may be at least one of polyester and nylon. Hence, the synthetic material of the second fabric may comprise a polyester, a nylon, or a combination thereof. As an example, the synthetic material may be of a silk-like material, such as polyester satin, nylon satin, and/or the like. The patient layer 120 has a first side 122 and a second side 124 (not shown), opposite to the first side 122 of the patient layer 120. Furthermore, the first side 122 of the patient layer 120 is configured to be in contact with the body of a patient.

The second side 124 of the patient layer 120 is attachable to the first side 112 of the support layer 110. Hence, the present invention provides for a two-layer patient sling 100. The second side 124 of the patient layer 120 may be attachable to the first side 112 of the support layer 110 by means of at least one of adhesives, mechanical features, interlocking joints, magnetic attachment, and hook-and-loop fasteners. In other words, the first side 112 of the support layer 110 may be reversibly attachable to the second side 124 of the patient layer 120. Hence, the patient layer 120 may be separated from the support layer 110 in order to e.g., be washed or changed into a new patient layer 120. The patient layer 120 may be re-attached to the support layer 110. According to another example, the patient layer 120 is sewn onto the support layer 110. According to FIG. 1, said seams are positioned perpendicular to an extension direction of the patient sling 100.

The patient sling 100 further comprises a plurality of lifting means 130 arranged along opposite edges of the support layer 110. The lifting means 130 of each opposite edge of the support layer 110 may be arranged with a uniform spacing. The lifting means 130 may be configured to be reversibly attachable to a patient lift system. The patient lift system may for example comprise at least one hook configured to receive and securely attach the plurality of lifting means 130 of the patient sling 100. The lifting means 130 may be of different length, or the same. For example, lifting means 130 arranged at positions of the support layer 110 where the head of a patient is intended to be positioned may have a shorter length compared to other lifting means 130 of the patient sling 100. Furthermore, the lifting means 130 may be length-adjustable. Thus, the lifting means 130 may be adaptable based on for example the size of a patient, or other desires and needs. The plurality of lifting means 130 may be releasably fixated to the support layer 110. Hence, the lifting means 130 may be separated from the support layer 110, and re-attached again. The lifting means 130 may be fixated to the support layer 110 by means of at least one of adhesives, mechanical features, interlocking joints, magnetic attachment, and hook-and-loop fasteners. Hence, the lifting means 130 may be separated from the support layer 110 in order to e.g., be washed and/or to not to be a hindrance for the patient and their surrounding environment. According to another example, the plurality of lifting means 130 is sewn onto the support layer 110.

The first fabric of the support layer 110 comprises a mesh structure. Thus, the mesh structure provides for an open-grid-like pattern. In other words, a plurality of openings, voids, cavities, open spaces, or the like is provided across the first fabric of the support layer 110. The mesh structure may be a 3D mesh structure. The mesh may be structured according to a regular or an irregular pattern. The mesh structure of the first fabric provides for a breathable support layer 110.

The first fabric comprising the mesh structure may cover only a portion of the support layer 110, or the entirety of the support layer 110. For example, in FIG. 1, the second side 114 (not shown) of the support layer 110 is entirely covered with the first fabric comprising the mesh structure. Furthermore, according in FIG. 1, the first side 112 of the support layer 110 comprises a first portion and a second portion. According to an example, the first portion of the first side 112 of the support layer 110 comprises the first fabric comprising the mesh structure. Moreover, the second portion of the first side 112 of the support layer 110 does not comprise the first fabric comprising the mesh structure. Instead, said second portion may comprise a third fabric. The third fabric of the support layer 110 may be of a breathable fabric. Furthermore, the third fabric may comprise a synthetic material. Said synthetic material may be at least one of polyester and nylon. Hence, the synthetic material of the third fabric may comprise a polyester, a nylon, or a combination thereof. The surface of the third fabric of the support layer 110 may be relatively smooth, even, uninterrupted, uniform, or the like, compared to the surface of the first fabric of the support layer 110. In other words, the surface of the third fabric may lack any protrusions, projections, abutments, elevations.

It should be noted that the first portion of the first side 112 of the support layer 110 is in fact a portion of the second side 114 of the support layer 110 which merely have been folded around the edges of the first side 112 of the support layer 110.

According to FIG. 1, the plurality of lifting means 130 of the patient sling 100 is attachable along said folded edges of the support layer 110.

The second fabric of the patient layer 120 comprises a woven structure. The woven structure comprises at least two sets of yarns, threads, or the like, perpendicularly interlacing each other. The woven structure allows for open spaces, pores, or the like, between the yarns. Hence, the woven structure of the second fabric provides for a breathable patient layer 120. Thus, the mesh structure of the first fabric of the support layer 110 and the woven structure of the second fabric of the patient layer 120 provide for a breathable support layer 110 and patient layer 120, respectively, thus resulting in a breathable patient sling 100. The support layer 110 may be arranged to receive at least a portion of at least one of moisture and heat from the patient layer 120 to transport away from the patient.

The patient sling 100 extends along a longitudinal direction, A_{L}, and a horizontal direction, A_{H}, perpendicular to the longitudinal direction, A_{L}. It should be noted that, according to FIG. 1, the support layer 110 extends beyond the patient layer 120 in the longitudinal direction, A_{L}, and the horizontal direction, A_{H}. Furthermore, as mentioned herein, the lifting means 130 are arranged along opposite edges of the support layer 110. Thus, according to FIG. 1, the lifting means 130 are arranged at a distance on the support layer 110 from the patient layer 120, wherein the patient layer 120 is configured to be in contact with the body of a patient. Therefore, the risk of a patient positioned on the patient sling 100 obtaining skin trauma from friction of the lifting means 130 may be reduced.

According to FIG. 1, the patient layer 120 as such extends along the longitudinal direction, A_{L}, and the horizontal direction, A_{H}, perpendicular to the longitudinal direction, A_{L}. The woven structure of the second fabric comprises a plurality of continuous filament fibres 140 (not shown), wherein at least a first portion of the plurality of continuous filament fibres 140 is arranged along the longitudinal direction, A_{L}, and at least a second portion of the plurality of continuous filament fibres 140 is arranged along the horizontal direction, A_{H}. By the use of continuous filament fibres 140, instead of for example short, staple fibres found in cotton, the patient layer 120 may reduce the risk of skin trauma of the patient due to friction, shear, and/or contraction. Instead, the patient layer 120 provides for a smooth, even, level, continuous, or the like surface to be in contact with the patient. In other words, the patient layer 120 avoids undesirable abutments, protrusions, elevations, projections, or the like to be in contact with the patient.

Furthermore, the plurality of continuous filament fibres 140 of the second fabric is arranged to establish micro-channels in the second fabric configured to transport at least one of moisture and heat away from the patient. For example, the micro-channels may be configured to wick moisture away from the skin of a patient by spreading it out across the patient layer 120. Therefore, the woven continuous filament fibres 140 of the patient layer 120 facilitates evaporation of moisture from the patient. The evaporation of moisture may provide for a cooling and comfortable sensation for the patient of the patient sling 100. According to an example, the plurality of continuous filament fibres 140 of the second fabric may have non-hygroscopic properties. In other words, the plurality of continuous filament fibres 140 of the second fabric has relatively low water absorption capacity, i.e., does not readily absorb or attract water molecules from their surroundings. The plurality of continuous filament fibres 140 will be further discussed herein in conjunction with further embodiments.

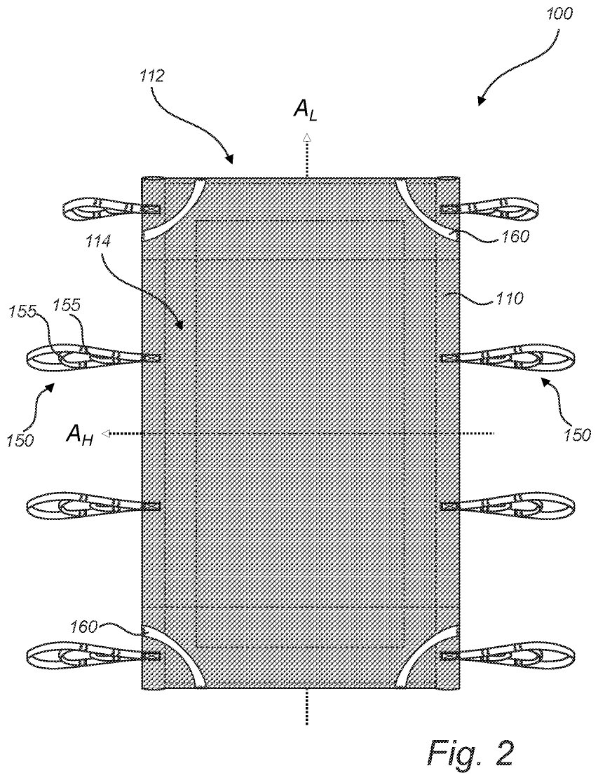

FIG. 2 is a schematic bottom view of a patient sling 100 according to an exemplifying embodiment of the present invention. It should be noted that the patient sling 100 shown in FIG. 2 has several features in common with the patient sling 100 shown in FIG. 1, and it is hereby referred to FIG. 1 and the associated text for an increased understanding of some of the features and/or functions of the patient sling 100.

The patient sling 100 in FIG. 2 comprises a support layer 110 and a patient layer 120 (not shown). In FIG. 2, a second side 114 of the support layer 110 is seen. The second side 114 is opposite the first side 112 (not shown) of the support layer 110 of the patient sling 100.

A plurality of lifting means, referred to as 130 in FIG. 1, is provided along opposite edges of the support layer 110. In this embodiment, the lifting means 130 are implemented as loops 150 to be hanged on e.g., one or several hooks of a patient lift system. However, even if loops 150 are relative easy and convenient to use for a user of the patient sling 100 when connecting the patient sling 100 to the patient lift system, the inventive concept is not limited to implement the lifting means as loops 150. Alternative lifting means or combinations of lifting means may be provided at the support layer 110. For instance, fixed or releasable handles, clamps, straps, eyelets, or the like may be arranged as alternative lifting means when appropriate. Also combinations of different types of lifting means may be applied to improve performance, when using the patient sling 100.

Each of the loops 150 may comprise one or more sub-loops 155 of different lengths, to make the lifting means 130 length-adjustable. Length-adjustable lifting means 130 facilitate the patient sling 100 to be adapted according to patients of different sizes, and/or to release pressure of sensitive areas of the skin of the patient. For instance, if a patient has skin wounds or pressure ulcers, adjusting the length of the lifting means 130 may reduce pain. Furthermore, the loops 150 of the patient sling 100 may be of different colours. For example, the colour, shape, and/or design of loops 150 arranged closest to a position on the patient sling 100 intended for positioning the head of a patient may be different compared to the colour, shape, and/or design of other loops 150 in order to clearly signify the intended position of the patient. Furthermore, each sub-loop 155 of a loop 150 may have different colour, shape, and/or design compared to each other in order to clearly signify the different lengths of the sub-loops 155 of a loop 150.

The support layer 110 is manufactured of a first fabric and is designed as a mesh structure. The mesh structure is suitable for transporting moisture and heat away from a patient placed in/on the patient sling 100. The mesh structure may further contribute to a comfortable and relatively soft sensation for the patient in the patient sling 100, and/or distribute the pressure evenly over the body of the patient. As mentioned herein, the plurality of continuous filament fibres 140 of the patient layer 120 is arranged to establish micro-channels in the second fabric configured to transport at least one of moisture and heat away from the patient. Hence, the support layer 110 and the patient layer 120 collectively contribute in transporting at least one of moisture and heat away from the patient.

In related exemplifying embodiments, which are based on the above described one, also the support layer 110 may extend in a longitudinal direction A_{L}, and in horizontal direction A_{H}, like the above described patient layer 120. In FIG. 2, the support layer 110 has a rectangular shape with the loops 150 (i.e. the lifting means 130) arranged at the two opposite edges extending along the longitudinal direction, A_{L}. However, the skilled person may design the patient sling 100 with alternative forms, e.g. with rounded corners, or with varying width along the support layer 110 within the inventive scoop. This may be beneficial to avoid tear of corners, to improve the lifecycle of the patient sling 100, and/or to make the patient sling 100 more comfortable for the patient.

The second fabric of the patient layer 120 may comprises an antimicrobial coating, e.g., antibacterial. The antimicrobial coating may be a chemical coating. The antimicrobial coating may comprise an active agent. The antimicrobial coating may be woven into, or otherwise bonded to, the patient layer 120. More specifically, the antimicrobial coating may be woven, or otherwise bonded, into the plurality of continuous filament fibres 140. The antimicrobial coating may prevent growth of bacteria and/or fungi.

Moreover, similarly as the patient layer 120 may have antimicrobial characteristics, also the support layer 110 may be treated with appropriate antimicrobial additives and/or have a physical structure that prevents growth of bacteria, viruses, or fungi. When the patient sling 100 is arranged in a bed, the second side 114 of the support layer 110 is designed to be in contact with a mattress in the bed.

Therefore, in yet another exemplifying embodiment, which is based on some above embodiments, the second side 114 of the support layer 110 has a higher coefficient of friction than the first side 112 of the support layer 110. Thereby, the second side 114 of the support layer 110 may prevent the patient sling 100 from slipping, gliding, separating, or the like from the mattress. To further fixate the patient sling 100 to the mattress, optional mattress fixation means 160 may be arranged at the second side 114 of the support layer 110. A plurality of mattress fixation means 160 in form of elastic bands are illustrated in FIG. 2. These mattress fixation means 160 will be further discussed below in conjunction with further embodiments.

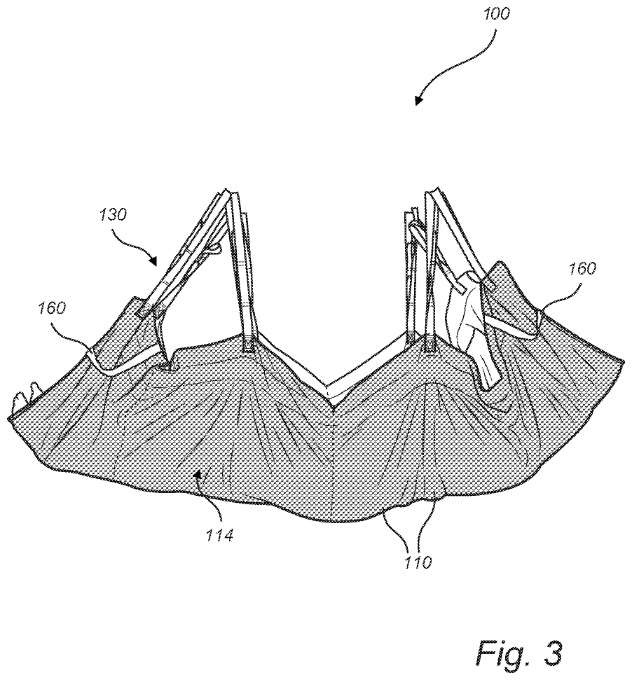

FIG. 3 is a schematic perspective view of a patient sling 100 according to an exemplifying embodiment of the present invention when attached to a patient lift system (not shown). It should be noted that the patient sling 100 shown in FIG. 3 has several features in common with the patient sling 100 shown in FIGS. 1 and 2, and it is hereby referred to FIGS. 1 and 2 and the associated text for an increased understanding of some of the features and/or functions of the patient sling 100.

In a situation, the patient sling 100 has been arranged on a patient lift system (not shown), and lifting means 130 in form of loops (referred to as 150 in FIG. 2) are hung up on respective hooks (not shown) of the patient lift system. The patient is lifted in the patient sling 100, e.g. for being moved from a bed to a wheelchair.

Furthermore, the optional mattress fixation means 160 in form of a plurality of elastics arranged in the corners of the second side 114 of the support layer 110 are illustrated after having been released from the mattress. In FIG. 3, the second side 114 of the support layer 110 is shown.

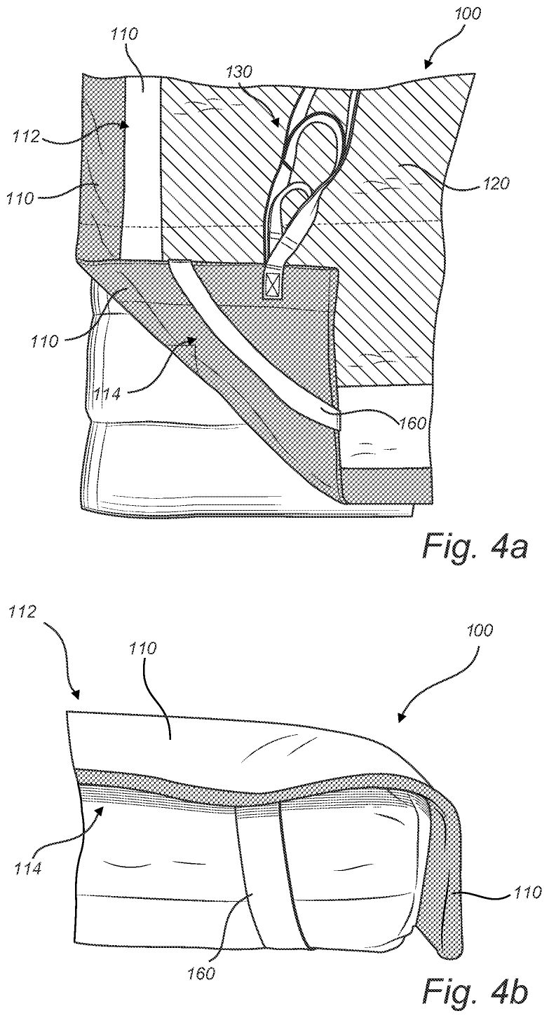

FIGS. 4a and 4b are selected enlarged schematic top and side views, respectively, of a patient sling 100 according to an exemplifying embodiment of the present invention. It should be noted that the patient sling 100 shown in FIGS. 4a and 4b has several features in common with the patient sling 100 shown in FIGS. 1 to 3, and it is hereby referred to FIGS. 1 to 3 and the associated text for an increased understanding of some of the features and/or functions of the patient sling 100.

FIG. 4a shows an enlarged schematic top view of a portion of the patient sling 100. As shown in FIG. 4a, the support layer 110 comprises mattress fixation means 160 configured to releasably fixate the patient sling 100 to a mattress. The mattress fixation means 160 may be configured to releasably fixate the patient sling 100 to other objects wherein, or whereupon, the patient and the patient sling 100 are positioned, for example in a wheelchair. The mattress fixation means 160 are arranged on the second side 114 of the support layer 110, according to FIG. 4a. Therefore, the mattress fixation means 160 does not pose a hindrance for the patient and their environment. Additionally, the arrangement of the mattress fixation means 160 prevents physical contact between the mattress fixation means 160 and the patient. Therefore, the mattress fixation means 160 allow for a secure fixation of the patient sling 100 to a mattress. At the same time, the mattress fixation means 160 does pose any harm to the patient by e.g., inflicting skin trauma to the patient by friction.

The mattress fixation means 160 are configured to be threaded around a mattress and comprises at least one of a plurality of elastic bands provided in corners of the support layer 110, and an elastic enclosure (not shown) arranged along the perimeter of the support layer 110. The patient sling 100 shown in FIG. 4a comprises a plurality of elastic bands in each corner of the support layer 110, wherein only one elastic band is visible for the sake of clarity. The elastic bands are arranged on the second side 114 of the support layer 110, as also visible in FIG. 4a. The elastic enclosure of the mattress fixation means 160 may be arranged along the perimeter of the support layer 110 on the second side 114 of the support layer 110. Thus, the elastic enclosure may enclose at least a portion of a mattress to securely fixate the patient sling 100 to a mattress. For example, the elastic enclosure may fully enclose all of the edges of a mattress as well as a portion of a side of the mattress opposite to the side of the mattress whereupon the patient lies. Thus, the elastic enclosure, together with the patient sling 100, may be equated to how a fitted sheet is designed and arranged on a mattress. According to an example, each of the lifting means 130 are attached to both the first side 112 and the second side 114 of the support layer 110, along opposite edges of the support layer 110. It should be noted that the lifting means 130 are arranged on the support layer 110 at a distance from the patient layer 120, wherein the patient layer 120 is configured to be in contact with the body of a patient.

FIG. 4b shows an enlarged schematic side view of a portion of the patient sling 100. The patient sling 100 according to FIG. 4b comprises the mattress fixation means 160 comprising a plurality of elastic bands provided in corners of the support layer 110, threaded around the mattress, wherein only one elastic band is visible for the sake of clarity. Furthermore, FIG. 4b shows the first side 112 and the second side 114 of the support layer 110. It should be noted that a portion of the second side 114 of the support layer 110 is folded around the edges of the first side 112 of the support layer 110. Consequently, a first portion of the first side 112 of the support layer 110 comprises the first fabric comprising a mesh structure, as shown in FIG. 4b. Furthermore, a second portion of the first side 112 of the support layer 110 may comprise a third fabric comprising a non-mesh structure. For example, the non-mesh structure may comprise a relatively smooth, even, uninterrupted, uniform, or the like, surface compared to the mesh structure of the first fabric. In other words, the surface of the third fabric may lack any protrusions, projections, abutments, elevations.

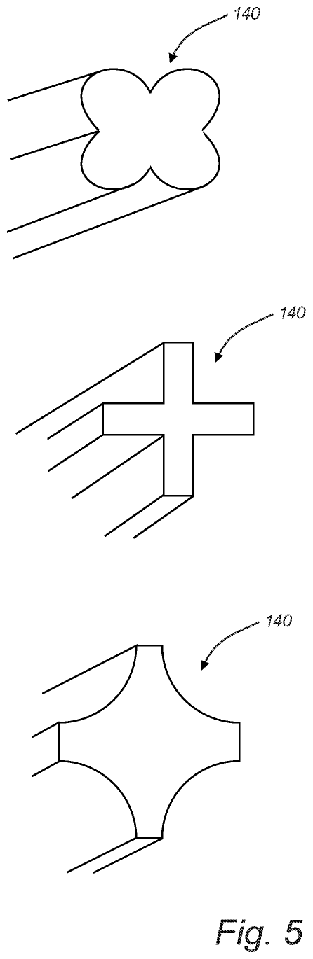

FIG. 5 is a schematic perspective view of various cross-sections of the plurality of continuous filament fibres 140.

For example, the plurality of continuous filament fibres 140 of the second fabric may have a clover-shaped cross-section. Furthermore, the plurality of continuous filament fibres 140 may have a cross-shaped cross-section, and/or a rounded cross-shaped cross-section. The plurality of continuous filament fibres 140 may have a combination of said shapes of their cross-section, or only one.

The plurality of continuous filament fibres 140 of the second fabric is arranged to establish micro-channels in the second fabric. The micro-channels are configured to transport at least one of moisture and heat away from the patient. According to an example, the micro-channels of the second fabric are established by the plurality of continuous filament fibres 140 of the second fabric having a clover-shaped cross-section. The established micro-channels of the second fabric of the patient layer 120 may be formed by concave portions of adjacent continuous filament fibres 140. For example, the micro-channels may be arranged along the longitudinal direction, A_{L}, and/or along the horizontal direction, A_{H}.

The person skilled in the art realizes that the present invention by no means is limited to the preferred embodiments described above. On the contrary, many modifications and variations are possible within the scope of the appended claims. For example, the patient sling 100, the support layer 110, the patient layer 120, etc., may have different shapes, dimensions and/or sizes than those depicted/described.

1. A patient sling for handling patients, comprising
a support layer comprising a first fabric, and having a first side and a second side opposite to the first side of the support layer,
a patient layer comprising a second fabric, and having a first side and a second side, opposite to the first side of the patient layer, wherein the second side of the patient layer is attachable to the first side of the support layer, and the first side of the patient layer is configured to be in contact with the body of a patient, and
a plurality of lifting means arranged along opposite edges of the support layer, wherein the first fabric comprises a mesh structure, and the second fabric comprises a woven structure.

2. The patient sling according to claim 1, wherein the first fabric comprises a first synthetic material, and the second fabric comprises a second synthetic material.

3. The patient sling according to claim 1, wherein the mesh structure of the first fabric is configured to transport at least one of moisture and heat away from the patient.

4. The patient sling according to claim 1, wherein the patient layer extends along an longitudinal direction, A_{L}, and a horizontal direction, A_{H}, perpendicular to the longitudinal direction, A_{L}, and wherein the woven structure of the second fabric comprises a plurality of continuous filament fibres, wherein at least a first portion of the plurality of continuous filament fibres is arranged along the longitudinal direction, A_{L}, and at least a second portion of the plurality of continuous filament fibres is arranged along the horizontal direction, A_{H}.

5. The patient sling according to claim 4, wherein the plurality of continuous filament fibres of the second fabric is arranged to establish micro-channels in the second fabric configured to transport at least one of moisture and heat away from the patient.

6. The patient sling according to claim 5, wherein the micro-channels of the second fabric are established by the plurality of continuous filament fibres of the second fabric having a clover-shaped cross-section.

7. The patient sling according to claim 1, wherein the second fabric comprises an antimicrobial coating.

8. The patient sling according to claim 1, wherein the first side of the support layer has a first coefficient of friction, and the second side of the support layer has a second coefficient of friction, wherein the second coefficient of friction is higher than the first coefficient of friction.

9. The patient sling according to claim 1, wherein the lifting means comprises loops.

10. The patient sling according to claim 9, wherein each of the loops of the lifting means are configured to be length-adjustable by comprising sub-loops, wherein each of the sub-loops of a loop is of different lengths.

11. The patient sling according to claim 1, wherein the support layer comprises mattress fixation means configured to releasably fixate the patient sling to a mattress.

12. The patient sling according to claim 11, wherein the mattress fixation means are configured to be threaded around the mattress and comprises at least one of
a plurality of elastic bands provided in corners of the support layer, and arranged on the second side of the support layer, and
an elastic enclosure arranged along the perimeter of the support layer.
